(19) United States
(12) Patent Application Publication
(10) Pub. No.: US 2008/0042406 A1
(43) Pub. Date: Feb. 21, 2008

(54) AUTOMOTIVE PSIR DOOR ANTI-WALK FEATURE

(76) Inventor: Gregg S. Evans, Windsor (CA)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/842,461

(22) Filed: Aug. 21, 2007

Related U.S. Application Data
(60) Provisional application No. 60/838,893, filed on Aug. 21, 2006.

(51) Int. Cl. B60R 21/20

(52) U.S. Cl. 280/728.3

(57) ABSTRACT

An automotive airbag system including a PSIR chute having a door end, and first and portions. The door end of the PSIR chute may include one or more openings, and a door may be connected to the door end of the PSIR chute. The door may include an inner edge and an outer edge, with the inner edge providing an axis about which the outer edge rotates upon deployment of an airbag. The inner edge may also include one or more tabs configured to pass through the opening of the PSIR chute and extend from the door area of the PSIR chute to a weld flange area of the PSIR chute. For the airbag system configured as discussed above, translation of the inner edge of the door is limited by the tab.

### RELATED APPLICATIONS

This application claims benefit of priority to Provisional Application Ser. No. 60/838,893, filed Aug. 21, 2006, hereby incorporated by reference in its entirety.

### BACKGROUND OF INVENTION

a. Field of Invention

The invention relates generally to automotive airbags, and more particularly to an apparatus and method for guiding opening of a Passenger Side Inflatable Restraint PSIR) door to prevent cracking of the door or the instrument panel during airbag deployment.

b. Description of Related Art

Automobiles are commonly equipped with airbags for reducing driver and passenger injuries in the case of an accident. Automobile airbags are generally located in areas where a driver or passenger would potentially contact an automobile interior in the event of an accident. Airbags can reduce injuries by providing a substantially non-solid surface for the driver or passenger to contact, as opposed to the generally solid surfaces of the automotive interior. Deployment of an airbag should not however augment the potential injuries a passenger may incur during the course of an accident.

In order to install an airbag, the airbag is generally folded into a module that is installed into or behind an automotive interior component. That is to say, an instrument panel may include a Passenger Side Inflatable Restraint (PSIR) chute protruding behind it, into which the airbag module is stored. A PSIR chute generally includes a set of doors through which the airbag will release. These doors generally line up with pre-weakened areas of the instrument panel. As such, the deployment of an airbag generally includes opening the doors of a PSIR chute and breaching the instrument panel at the pre-weakened areas. It is desirable for these actions to take place smoothly and in a predictable manner. Variations in these actions could interfere with the deployment of the airbag, or cause additional hazards to an automobile passenger.

A known set of PSIR chute doors includes a forward door and a rear door. The forward door is commonly the door located closer to the windshield, such that the axis about which the forward door rotates is both close to, and substantially parallel to, the automobile windshield. The rear door is commonly a mirror image door, with the axis located closer to the interior of the automobile. Known hinges for the doors' axes vary significantly, as apparent in the disclosures of U.S. Pat. No. 5,456,487 to Daris et al., U.S. Pat. No. 5,275,432 to Pray et al, and U.S. Pat. No. 5,280,947 to Cooper.

Ideally with the known hinges, the edge of the door closest to the axis would remain stable and not travel, providing a steady axis about which the opposite edge of the door may rotate. However, notwithstanding the variety of known doors and hinges, there remains a problem of a door “walking” upon airbag deployment. It is known for the edge of a door closest to an axis to “walk” or travel due to the force of the airbag during deployment. The edge of the walking door may collide with the instrument panel, crack upon a collision, and/or crack the instrument panel.

As readily apparent, such cracking of the door or the instrument panel is undesirable as it may generate fragments that are objectionable, primarily for reasons of eye safety, in that, during passenger air bag deployment, the fragments may become a source of flying projectiles. Further, as readily evident, any variation in the performance of the door may hinder the deployment of the airbag.

It would therefore be of benefit to provide an economical and efficient method of deploying PSIR doors without colliding with the instrument panel to thus avoid cracking of the doors or the instrument panel, and reducing the potential variations in a door's performance.

### SUMMARY OF INVENTION

The present invention thus solves the problems and overcomes the drawbacks and deficiencies of prior art airbag systems by providing an automotive airbag system including a PSIR chute having a door end, and first and second portions. In an exemplary embodiment, the PSIR chute may include two doors attached to an inner wall (i.e. on the first portion side) of the chute by means of hinge loops. The door end of the PSIR chute may include one or more openings, and as discussed above, a door may be connected to the door end of the PSIR chute by means of the hinge loops. The door may include an inner edge and an outer edge, with the inner edge providing an axis about which the outer edge rotates by means of the hinge loops (which connect the inner edge to the chute wall) upon deployment of an airbag. The inner edge may also include one or more tabs configured to pass through the opening of the PSIR chute and extend from a door area of the PSIR chute to a weld flange area of the PSIR chute. For the airbag system configured as discussed above, translation of the inner edge of the door is limited by the tab, forcing a substantially rotary motion.

For the system described above, the system may further include a hinge (i.e. the aforementioned hinge loop) connected to the inner edge of the door and connected to the first portion (i.e. inner wall) of the PSIR chute, allowing the outer edge of the door to rotate about the hinge. The hinge may allow for the door to open away from the PSIR chute and allow an airbag to be deployed therethrough. Upon deployment of an airbag, the inner edge of the door may be secured by the tab, thus precluding “walking” of the inner edge of the door.

The airbag system above may include a plurality of tabs, and/or may include a plurality of hinges. The hinges and tabs may be configured in an alternating arrangement, providing for a tab to be flanked by hinges and vice versa. The airbag system above may include a plurality of openings in the PSIR chute, in accordance to the tabs provided in the system.

The first portion (i.e. inner wall) of the PSIR chute may be a chute into which an airbag module may be attached and the second portion of the PSIR chute may be a panel substantially perpendicular to the opening of the chute, onto which an instrument panel may be attached. Those in the art would appreciate that the panel of the PSIR chute may include curvatures, as per the curvature of an instrument panel. For the system described above, the door end PSIR chute may include an “H” type PSIR door system, which may include two substantially mirroring doors.

The invention also provides an airbag door assembly including a door having a hinging edge, and the hinging edge farther including a hinge (i.e. the aforementioned hinge loop) and a tab. The hinge and the tab may be integrally formed to the door. The hinge may be configured to connect to a PSIR chute in a location interior to the location of the tab. Namely, the hinge may be configured to connect to a PSIR chute, whereas the tab may be configured to pass through the chute. The assembly may further include a plurality of hinges and a plurality of tabs.

The invention yet further provides an automotive air bag system including a PSIR chute having a door area and a weld flange area, and a PSIR door connected to the door area and including an inner edge and an outer edge. The inner edge may provide an axis about which the outer edge rotates upon deployment of an airbag, and the inner edge may include one or more tabs configured to extend into the weld flange area to limit translation of the PSIR door during airbag deployment.

For the automotive air bag system described above, the tab may further include a first end and a second end, with the first end connected to the door and the second end passing through an aperture of the PSIR chute. The system may further include a hinge connected to the door and connected to the door area of the PSIR chute, the hinge allowing the outer edge of the door to rotate.

The invention yet further provides an airbag system made by providing a PSIR chute having a weld flange portion and a chute portion, and including one or more openings on the chute portion of the PSIR chute. The system may be made by further providing a door having one or more hinges and one or more tabs, connecting the hinge to the chute portion of the PSIR chute, and connecting the tab to the panel portion of the PSIR chute, wherein the tab portion strengthens the hinge and secures the door. The system may be made by bonding an instrument panel to the weld flange portion of the PSIR chute and/or weakening the instrument panel in areas aligning with the door. For the method of making the airbag system described above, providing a door may include providing a door with an integrally molded hinge and tab.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an illustration of an instrument panel including a related art (vibration welded) air bag chute and corresponding forward and rearward PSIR doors (H pattern style);

FIG. 2 is an illustration of the instrument panel of FIG. 1, illustrating the forward PSIR door in an intermediate deployment state;

FIG. 3 is an illustration of the instrument panel of FIG. 1, illustrating the forward PSIR door in a fully deployed state;

FIG. 4 is a cross-sectional illustration of an instrument panel including an air bag chute and a corresponding forward PSIR door according to the present invention, taken substantially along line 4-4 in FIG. 6 (but with forward PSIR door in an un-deployed state);

FIG. 5A is a cross-sectional illustration of the instrument panel of FIG. 4, illustrating the forward PSIR door in a fully deployed state, taken substantially along line 5A-5A in FIG. 6 (note hinge loops of FIG. 4 are not shown);

FIG. 5B is a cross-sectional illustration of the instrument panel of FIG. 4, illustrating the forward PSIR door in a fully deployed state, taken substantially along line 5B-5B in FIG. 6 (note hinge loops of FIG. 4 shown); and

FIG. 6 is a front view of the forward PSIR door of FIG. 4 in its fully deployed state.

### DETAILED DESCRIPTION OF THE PREFERRED EMBODIMENTS

Turning now to the drawings wherein like reference characters refer to like and corresponding parts throughout the several views, FIGS. 4-6 illustrate various diagrams for a Passenger Side Inflatable Restraint (PSIR) door attachment method according to the present invention.

Before proceeding with a description of the PSIR door attachment method according to the present invention, the attachment method and deployment of a related art PSIR door will be described in detail with reference to FIGS. 1-3.

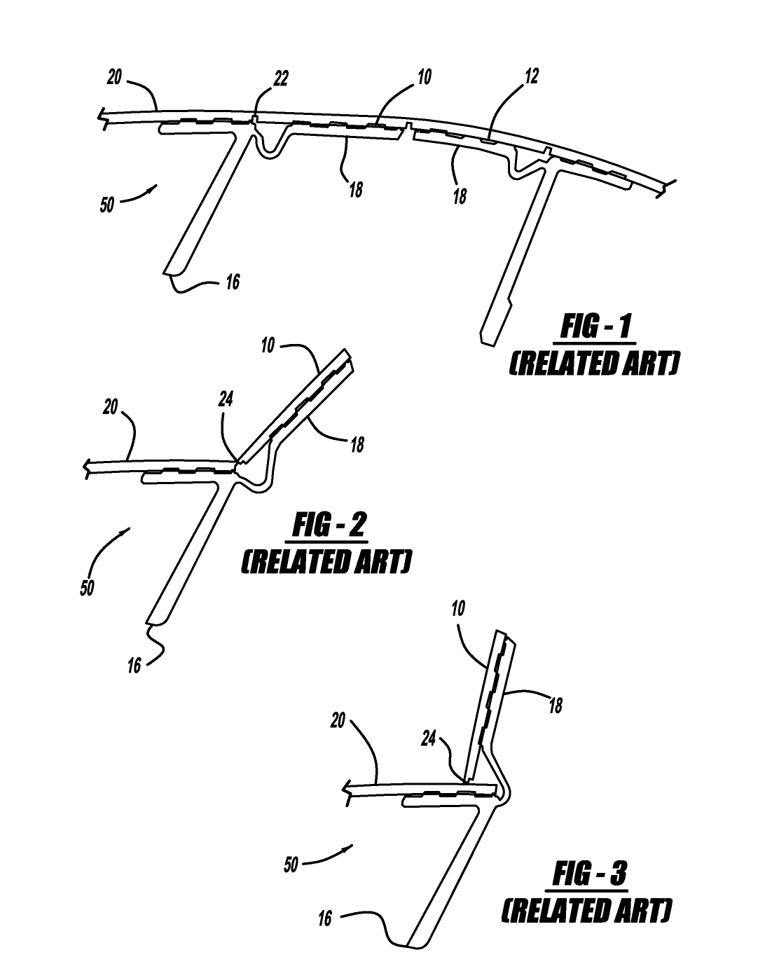

As illustrated in FIGS. 1-3, a related art airbag assembly 50 may include doors 10, 12 welded to chute 16 by a hinge flange 18. As illustrated, forward PSIR door 10 may be the door adjacent a windshield (not shown) and rearward PSIR door 12 may be the door closest to the passenger. PSIR doors 10, 12 may be generally formed from hinge flange 18 and the outer layer of an instrument panel 20 having weakening score line 22 formed therein for allowing opening of each door during air bag deployment as shown in FIGS. 2 and 3 (note only door 10 illustrated). Referring to FIG. 2, during such deployment of the air bag, doors 10, 12 may respectively rotate in counter clockwise and clockwise directions. Referring to FIG. 3, doors 10, 12 (only door 10 illustrated) may each continue to rotate so that door 10 detaches from the instrument panel structure at score line 22 and translates (i.e. walks) in the opening direction. This phenomenon causes edge 24 of door 10 (and similar edge of door 12) to collide with instrument panel 20, and thus crack edge 24 as well as the instrument panel due to the speed of deployment.

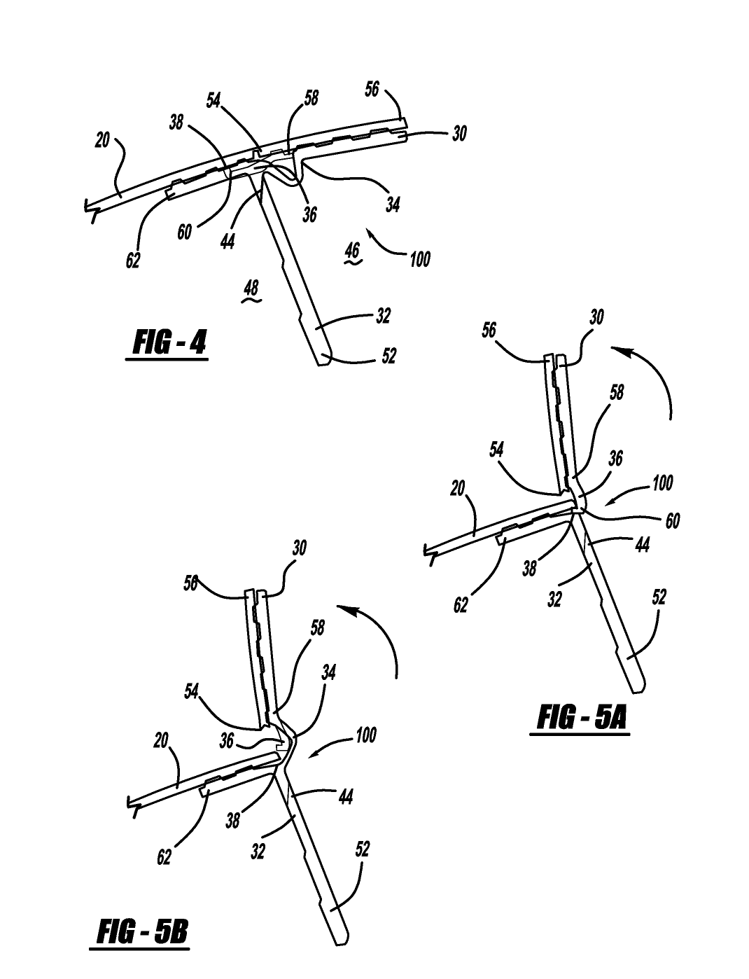

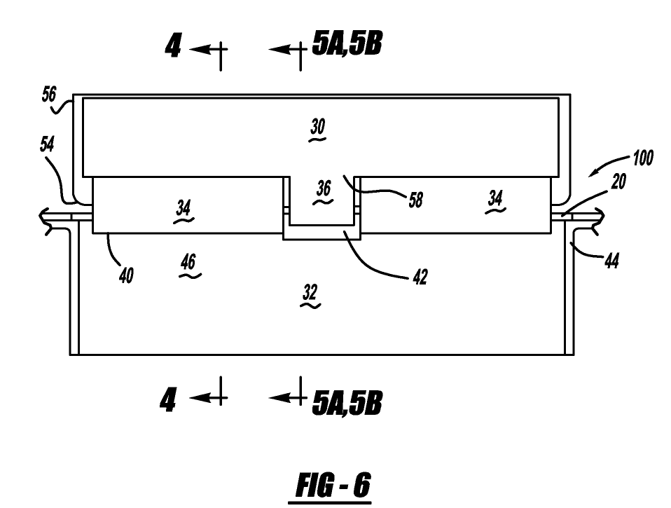

b order to prevent cracking of edge 24 of PSIR doors 10, 12 and the surface of instrument panel 20 during air bag deployment (illustrated in FIGS. 1-3), the present airbag assembly 100, illustrated in FIGS. 4-6, provides a forward PSIR door 30 operatively connected to air bag chute 32 by a hinge 34. Instrument panel 20 may be vibration welded to or connected via other known connecting mechanisms to door 30. One or more rigid, metallic or otherwise formed tabs 36 may be fixedly connected to or otherwise formed with door 30 and disposed adjacent airbag chute 32 at location 38. In the embodiment illustrated, tab 36 may include a hooked configuration, but may otherwise be formed without the hook as long as the tab extends toward the PSIR chute weld flange area, or beyond the scored weakening illustrated in FIG. 4. Further, in the embodiment illustrated, tab 36 may be partially disposed under instrument panel 20 as also illustrated in FIG. 4. Notably, location 38 may extend past hinge 34 connection location 40, provided chute 32 includes an opening 42 through which the tab may pass. Although not illustrated, the rearward PSIR door may be similarly mounted to the air bag chute assembly by a tab (not shown). In this manner, as shown in FIGS. 5A and 5B which has hinge 34 removed from view, upon deployment of the air bag, forward PSIR door 30 may rotate in a counter clockwise direction while “walking” (translation) is prevented by tab 36. Rearward PSIR door (not shown) may likewise rotate in a clockwise direction while “walking” (translation) is prevented by a similar tab 36.

Also, as illustrated in FIGS. 4-6, airbag chute 32 may have a door end 44, first portion 46 (near the chute inner wall), and second portion 48, with door end 44 including door 30 and being closer to instrument panel 20 than the opposing end. The first portion 46 of airbag chute 32 may be the portion including chute 52, and the interior thereof, whereas, the second portion 48 may be the portion exterior of chute 52. Chute 52 may be where an airbag module (not shown) may attach/hook thereon. Another feature of airbag chute 32 may be a planar surface 62 for bonding to instrument panel 20, through vibration welding, through the use of an adhesive, or similar bonding methods.

Door 30 may have an inner edge 54 and an outer edge 56, where inner edge 54 provides an axis about which outer edge 56 may rotate upon deployment of an airbag, and where inner edge 54 may have tab 36 which is configured to pass through opening 42 and extend from first portion 46 to second portion 48. Tab 36 may include first end 58 and second end 60, where first end 58 is connected to, or integrally formed with door 30, while second end 60 is disposed within opening 42 of chute 52. The present invention may also include more than one tab 36, which may pass through more than one openings 42 as needed.

The invention further provides for a method of manufacturing an airbag system as discussed above. The method may include providing airbag chute 32 having planar surface 62, chute 52 and including opening 42 in airbag chute 32. The defining of an opening in chute 32 may include molding an opening into airbag chute 32, or by incising such an opening. The manufacturing method may further include providing door 30 having hinge 34 and tab 36. Additionally, the method may include connecting hinge 34 to chute 52, and placing tab 36 in opening 42 of chute 52. This method allows for tab 36 to bolster hinge 34 and secure door 30. Further, the method may include bonding instrument panel 20 to airbag chute 32 and/or weakening instrument panel 20 in areas aligning with door 30 (i.e. by providing adequate scoring as is known in the art). Hinge 34 and tab 36 may be integrally molded with door 30, may be formed of a metallic or rigid plastic material, or may be connected to door 30 by nut/bolt, rivet, welding, and similar connection methods.

The invention thus provides an economical and efficient method of deploying PSIR doors in such a way that door rotation is sufficiently advanced without door to instrument panel contact, to thus avoid door locking and cracking of the PSIR doors or the instrument panel.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. An automotive air bag system comprising:
a PSIR chute having a door end, a first portion, and a second portion, the door end of the PSIR chute including at least one aperture; and
a door connected to the door end of the PSIR chute, the door having an inner edge and an outer edge, the inner edge providing an axis about which the outer edge rotates upon deployment of an airbag, and the inner edge having at least one tab configured to pass through the aperture of the PSIR chute and extend from the first portion of the PSIR chute to the second portion of the PSIR chute;
wherein translation of the inner edge of the door is limited by the tab.

2. An automotive air bag system according to claim 1, wherein the tab further includes a first end and a second end, the first end is connected to the door and the second end passes through the aperture of the PSIR chute.

3. An automotive air bag system according to claim 1, further comprising a hinge connected to the door and connected to the first portion of the PSIR chute, the hinge allowing the outer edge of the door to rotate.

4. An automotive air bag system according to claim 1, further comprising a plurality of tabs.

5. An automotive air bag system according to claim 1, wherein the PSIR chute includes a plurality of apertures.

6. An automotive air bag system according to claim 1, wherein the first portion of the PSIR chute includes a chute into which an airbag module is attachable.

7. An automotive airbag system according to claim 1, wherein the second portion of the PSIR chute is a substantially planar surface bondable to an instrument panel.

8. An automotive airbag system according to claim 1, her including doors in an “H” type configuration.

9. An automotive air bag system comprising:
a PSIR chute having a door area and a weld flange area; and
a PSIR door connected to the door area and including an inner edge and an outer edge, the inner edge providing an axis about which the outer edge rotates upon deployment of an airbag, and the inner edge includes at least one tab configured to extend into the weld flange area to limit translation of the PSIR door during airbag deployment.

10. An automotive air bag system according to claim 9, wherein the tab further includes a first end and a second end, the first end is connected to the door and the second end passes through an aperture of the PSIR chute.

11. An automotive air bag system according to claim 9, further comprising a hinge connected to the door and connected to the door area of the PSIR chute, the hinge allowing the outer edge of the door to rotate.

12. An automotive air bag system according to claim 9, further comprising a plurality of tabs.

13. An automotive air bag system according to claim 10, wherein the PSIR chute includes a plurality of apertures.

14. An automotive airbag system according to claim 9, further including PSIR doors in an “H” type configuration.

15. A method of manufacturing an airbag system comprising:
providing a PSIR chute having a panel portion and a chute portion;
forming at least one aperture on the chute portion of the PSIR chute;
providing a door having at least one hinge and at least one tab;
connecting the hinge to the chute portion of the PSIR chute; and
connecting the tab to the panel portion of the PSIR chute, wherein the tab portion strengthens the hinge and secures the door.

16. The method according to claim 15, further comprising:
bonding an instrument panel to the panel portion of the PSIR chute.

17. The method according to claim 16, further comprising:
weakening the instrument panel in areas aligning with the door portion of the PSIR chute.

18. The method according to claim 15, wherein providing a door includes providing a door with an integrally molded hinge and tab.
